(19) United States
(12) Patent Application Publication
(10) Pub. No.: US 2012/0047077 A1
(43) Pub. Date: Feb. 23, 2012

(54) VIRTUAL STUDIO FOR IDENTIFYING AND DEVELOPING PUBLIC TALENT

(76) Inventor: SCOTT HUMPHREY, Hollywood, CA (US)

(21) Appl. No.: 12/861,802

(22) Filed: Aug. 23, 2010

(51) Int. Cl. G06Q 50/00; G06Q 10/00; G06F 17/00

(52) U.S. Cl. 705/300; 700/94

(57) ABSTRACT

The teachings generally relate to a method of creating a derivative artistic work that includes a select, virtual submission from the public obtained from a set of random, virtual submissions submitted, for example, through a network or public venue. The teachings are directed a virtual studio, a method of creating a derivative, multi-track musical work that includes a virtual performance from the public.

### BACKGROUND

1. Field of the Invention

The teachings generally relate to a method of creating a derivative, multi-track musical work that includes a select, virtual performance from the public obtained from a set of random, virtual performances submitted through a network.

2. Description of the Related Art

A dream shared among most of the human race is that of becoming a star, a celebrity, or at least an accomplished artist entitled to some acclaim. Unfortunately, most talented people are never recognized, as many of these people never have the right connections to the right people, the ability to be at the right place at the right time, or the right amount of time and money to even get to the right people in the right places. In fact, it's become quite cliché. For at least these reasons, many very talented people have to give up their dream without ever having a chance at a single serious review of their talents.

Most would agree that society has reached a sort of “information overload,” where information and entertainment is now available to nearly everyone, worldwide, from almost anywhere, almost immediately, at an unprecedented level. Most would also agree that this information overload is due primarily to the exponential growth of the internet, a new paradigm in communicating worldwide, nothing less than a technical and cultural evolution in the sharing of ideas, facts, and artistic expression. One form of artistic expression enjoyed worldwide is music, and this is an enjoyment that has been handed down for generations in our culture.

The Internet has decimated the traditional sale of music due to piracy, through file sharing, for example. A fragmented landscape has formed that offers a staggering amount of entertainment choices, and this fragmentation of the landscape makes it almost impossible for even the most accomplished, well-connected artists to gain traction. Traditional radio has turned-off the average listener due to having an average of 20 minutes of commercial time per hour, as well as shortened playlists that make it nearly impossible for even the most established artists to be added into a rotation. Television, a long-favored way of getting mass exposure, is no longer an attractive option, as MTV, previously one of the main drivers of the music culture between 1980 and 2000, no longer airs music videos. These combined factors have reduced revenues in the music industry tremendously, leaving artists with very little money to record, and have resulted in a reduced motivation to create and market new music.

For at least the above reasons, the music industry has been hit hard financially, as the traditional methods of developing a public interest in the work of existing artists, and identifying and developing new talent, appear to no longer function well in today's world. A new business model is needed in the music industry, a new paradigm that uses the extensive and highly cost-effective reach of the internet. The model should use the incredible penetration and speed of the internet to reach out quickly to the masses through a public venue to regain, strengthen, and build the public's interest in existing talent, as well as in identifying and developing new talent. Such a model should also support the continued growth of the music industry by creating new music fans, educating and entertaining the fans, and enhancing the interest in the musical arts worldwide. Moreover, such a model could also renew the dream of becoming a star to those that thought they had to give up the dream due to the traditional limitations of the music industry.

Part of the solution to the problems discussed above should include reducing costs associated with identifying and developing talent. Many such costs could be reduced, for example, by engaging fans to participate in the creation of the multi-track master, and further promote the industry, from their home studios. In this way, the participating fans naturally become free marketing vehicles, each one excited about the opportunity and the creation, spreading the word virally through the many forms of social media during the entire recording process. The teachings presented herein provide a vehicle for fans to participate in the recording process, fuel an awareness of the artist's new music before it's completed, and promote their own musical skills.

Accordingly, those of skill in the art in the music industry will appreciate having a way to harness the power of the internet to strengthen and advance developments in the industry. The method can potentially give every artist at least single serious review of their talents through a single connection that they likely already have: an internet connection. The teachings provided herein are directed to the only known way of accomplishing this objective: (i) reaching, reviewing, and managing submissions from the masses, whether worldwide, nationwide, statewide, or regionally from a single forum that's internet accessible; (ii) offering the masses an opportunity to submit virtual performances through the forum for review and possible inclusion in a musical work with a popular artist; (iii) providing the masses with a reference file from the popular artist; (iv) advancing and sharing the goodwill of the popular artist with a select, virtual performer; and (v) transforming the select, virtual performance into the derivative, multi-track musical work. World renowned artists have simply not made their unfinished tracks available to the general public on a massive scale to participate in the recording process for the creation of a multi-track master for commercial release. As such, the teachings provided herein include a type of musical work that is the first of its kind in the history of music production.

### SUMMARY

The teachings generally relate to a method of creating a derivative artistic work that includes a select, virtual submission from the public obtained from a set of random, virtual submissions submitted, for example, through a network or public venue. In some embodiments, the teachings are directed to a method of creating a derivative, multi-track musical work that includes a virtual performance from the public.

In the teachings provided herein, the methods can comprise creating a reference file for a musical work comprising a plurality of audio tracks, each of the plurality of audio tracks in alignment with an alignment component. The methods can also include providing the reference file to random, virtual performers over a network, such as a computer network. In some embodiments, the network is accessible through a handheld wireless device. The method also includes developing a derivative, multi-track musical work having a select, virtual performance from the public.

In the teachings provided herein, the developing can include obtaining a set of random, virtual performances from the random, virtual performers, each virtual performance in the set comprising a derivative track having a virtual performer performing the derivative track without an accompaniment of the reference file and in alignment with the alignment component. In some embodiments, the alignment component can comprise a metronome track. And, each virtual performance in the set can also comprise a reference-mix track having the virtual performer performing the derivative track with the accompaniment of the reference file.

The methods taught herein can also include choosing the select, virtual performance from the set of random, virtual performances; and, transforming the select, virtual performance into the derivative, multi-track musical work. In some embodiments, the random, virtual performances are not real-time performances, as there is a delay between a transmitting of a random, virtual performance by the virtual performer to a reviewer and a reviewing of the virtual performance by the reviewer. And, in some embodiments, the delay can substantially exceed a normal delay associated with the transmitting and receiving of a live audio transmission.

In the teachings provided herein, the set of random, virtual performances can comprise an individual performance, such that the virtual performer consists of a single performer; or, a group performance, such that the virtual performer consists of a plurality of performers. Moreover, the providing can include instructing the random, virtual performers in how to meet a criteria desired for the select, virtual performance.

The teachings are also directed to a method of creating public interest in a musical work. In these embodiments, the method can comprise creating a reference file for a musical work comprising a plurality of audio tracks, each of the plurality of audio tracks in alignment with an alignment component. In these embodiments, the method can include making a public offering of an opportunity for random, virtual performers to submit virtual performances for inclusion in a derivative, multi-track musical work containing a select, virtual performance. The offering can include providing the reference file to the random, virtual performers through a public venue. And, in some embodiments, the select, virtual performer can be given a consideration. The consideration, for example, can comprise an affiliation with the goodwill of a popular artist in the creation of the musical work.

In some embodiments, the public venue comprises a television broadcast, a radio broadcast, or a satellite broadcast. And, in some embodiments, the venue can be provided by a computer network, or be coupled to a computer network. Moreover, the venue can be accessible by a handheld wireless device, in some embodiments.

The teachings are also directed to a method of creating a public interest in a musical artist through offering the public a virtual performance with a popular artist. In these embodiments, the method can comprise attracting random, musical performances on a mass scale from the public by offering the public an opportunity to provide a virtual, submission to a popular artist through a public venue. The offering can include an association with the goodwill of a popular artist through the creation of a musical work with the popular artist if chosen as a select, virtual performer.

The teachings are also directed to a virtual recording studio. In these embodiments, the virtual recording studio can comprise, for example, components that include an offering module, an instruction module, an input device, a music database, a subject-profile module, a solutions module, an integration engine, and a graphical user interface.

The offering module can be embodied in a computer readable storage medium and operable for offering an opportunity to provide a submission of a random, virtual performance to a popular artist through a public venue. The offering can include an association with the goodwill of the popular artist through the creation of a musical work with the popular artist if chosen as a select, virtual performer.

The instruction module can be embodied in a computer readable storage medium and operable for providing virtual instruction to the user regarding a criteria for making a random, virtual submission through the public venue. The input device can allow a user to enter a personalized subject-profile into a computing system. And, the personalized subject-profile can comprise a questionnaire designed to obtain information to be used to produce a personalized file for the user.

The music database can be embodied in a computer readable storage medium and operable to store a library of music comprising reference files for multi-track, musical works. And, the subject-profile module can be embodied in a computer readable storage medium and operable for receiving the personalized subject-profile and converting the personalized subject profile into a virtual performer profile. The virtual performer profile can comprise a virtual performance from the user and can include an identification of a select artist; a reference file, or a link to the reference file, for a select, multi-track musical work having an alignment component; a derivative track created by the user; and, a reference-mix track created by the user.

The solutions module can be embodied in a computer readable storage medium and operable for parsing music in the music database into audio track stems in response to the user's selection of the artist and the reference file. The integration engine can be embodied in a computer readable storage medium and operable for compiling the derivative track with the reference file using the alignment component. And, the graphical user interface can be used for displaying video, audio, and/or text to the user. Of course, the studio will have a processor.

Any of the modules or engines can have additional functions, and additional modules and engines can be added for additional functions. The integration engine can also be used, for example, for identifying flaws in the derivative track for rejecting the random, virtual performance as an automated pre-screening.

In some embodiments, the studio can include security measures to protect the user's privacy, integrity of data, or both. And, the studio can further comprise a response module embodied in a computer readable storage medium for matching the virtual performer profile with the automated pre-screening to provide an automated status report to the user.

The teachings are also directed to a musical work. In these embodiments, the musical work can be a multi-track, derivative musical work including a select, virtual performance from a set of random, virtual performances from the public. The select, virtual performance can be obtained from a process including a review of musical performances on a mass scale from the public that were obtained by offering the public an opportunity to provide a virtual, submission to a popular artist through a public venue. In these embodiments, the offering can include an association with the goodwill of the popular artist through the creation of a musical work with the popular artist, if chosen as a select, virtual performer. The review can include a process comprising (i) obtaining a reference file for the musical work, the reference file comprising a plurality of audio tracks and an alignment component; and (ii) providing the reference file to random, virtual performers through the public venue. And, the multi-track, derivative musical work can be developed as described herein.

The teachings are also directed to a system and method of identifying and developing a public talent. The system and method comprise obtaining a set of random, virtual expressions from the public; choosing a select, virtual expression for the set of random, virtual expressions; and, transforming the select, virtual expression into a developed expression. The select, virtual expression can be original or derivative.

### BRIEF DESCRIPTION OF THE FIGURES

FIG. 1 shows a general technology platform for a virtual studio, according to some embodiments.

FIG. 2 illustrates a processor-memory diagram to describe components of a virtual studio, according to some embodiments.

FIG. 3 is a concept diagram illustrating the virtual studio, according to some embodiments.

FIG. 4 illustrates the studio from the perspective of a featured artist offering an opportunity for random, virtual performers to submit virtual performances for inclusion in a derivative, multi-track musical work through a primary server, according to some embodiments.

FIG. 5 illustrates the studio from the perspective of a featured artist offering an opportunity for random, virtual performers to submit virtual performances for inclusion in a derivative, multi-track musical work through a primary server in conjunction with a remote server, according to some embodiments.

FIG. 6 shows how a network may be used for the virtual studio, in some embodiments.

### DETAILED DESCRIPTION

The teachings generally relate to a method of creating an artistic work that includes a select, virtual submission from the public obtained from a set of random, virtual submissions submitted through a network or public venue. In some embodiments, the artistic work can comprise an original expression, a derivative expression, or both, and can include any human expression known to one of skill. In some embodiments, for example, the “artistic work” can include literary works; musical works, including any accompanying words; dramatic works, including any accompanying music; pantomimes and choreographic works; pictorial, graphic, and sculptural works; motion pictures and other audiovisual works; sound recordings; and architectural works. In some embodiments, the artistic works can comprise any subject matter considered to be a copyrightable expression when interpreted by the U.S. copyright laws.

The teachings are also directed to a system and method of identifying and developing a public talent. The system and method comprise obtaining a set of random, virtual expressions from the public; choosing a select, virtual expression for the set of random, virtual expressions; and, transforming the select, virtual expression into a developed expression. The select, virtual expression can be original or derivative, and their submission can be real-time or not real-time. The expressions are “virtual” in that they are being submitted through a public view over a network or coupled to a network, as described herein.

The teachings include a method of creating a derivative, multi-track musical work that includes a virtual performance from the public. The methods can comprise, for example, creating a reference file for a musical work comprising a plurality of audio tracks, each of the plurality of audio tracks in alignment with an alignment component.

A derivative, multi-track musical work includes a virtual performer's interpretation of all or a portion of an original musical work and may be in the form of a virtual performance as described herein. In some embodiments, for example, a derivative work can be described as an expressive creation that includes major, copyright-protected elements of an original, previously created first work. And, in some embodiments, a “derivative work” can be a work based upon one or more preexisting works, such as a translation, musical arrangement, dramatization, fictionalization, motion picture version, sound recording, art reproduction, abridgment, condensation, or any other form in which a work may be recast, or transformed in a virtual performance.

In some embodiments, the teachings provide a virtual studio environment for identifying and developing public talent through virtual performances. A virtual performance can include, for example, any performance that is not in the physical presence of the reviewer of the performance. The performances can be real-time, or not real-time.

In some embodiments, the virtual performance is not a real-time performance, where there is a delay between a transmitting of a random, virtual performance by the virtual performer to a reviewer and a reviewing of the virtual performance by the reviewer. And, in some embodiments, the delay can substantially exceed a normal delay associated with the transmitting and receiving of a live audio transmission. In some embodiments, the virtual performance is not a real-time performance, where there is a delay between a receiving of a random, virtual performance by a reviewer and a reviewing of the virtual performance by the reviewer. In some embodiments, the delay can be seconds or minutes. In some embodiments, the delay can be hours or days. And, in some embodiments, the delay can be months or years.

In some embodiments, the virtual performance is a real-time performance, where there is no substantial delay between a transmitting of a random, virtual performance by the virtual performer to a reviewer and a reviewing of the virtual performance by the reviewer. And, in some embodiments, the delay does not substantially exceed a normal delay associated with the transmitting and receiving of a live audio transmission. In some embodiments, the virtual performance is a real-time performance, where there is no substantial delay between a receiving of a random, virtual performance by a reviewer and a reviewing of the virtual performance by the reviewer.

The reference file for a musical work can comprise a plurality of audio tracks, or “stems.” Each of the stems can compose a distinct portion of the musical work. And, each portion can be any sound, musical instrument, or vocal, known to one of skill in the art. In some embodiments, there may be a stem for a vocal, a stem for a guitar, a stem for drums, a stem for a keyboard, or perhaps stem for some other instrument. One of skill will appreciate that any musical work can have any number of stems in the plurality of audio tracks that compose the entirety of the musical work. In some embodiments, each individual source of a sound within a musical work can have an independent stem. And, in some embodiments, individual sources of sounds may share a stem. In fact, a stem may, in some embodiments, comprise a file that also includes other expressions, such as imagery, text, or video.

The alignment component can include any mechanism or method that functions as an audio track synchronization tool, a device used to assist a virtual performer, or reviewer of a virtual performance, in the alignment of the virtual performance with one or more other audio tracks. In some embodiments, the reference file comprises a plurality of audio tracks, and at least one of the audio tracks is aligned with the alignment component. It should be appreciated that the reference file can be interpreted by the virtual performer through the alignment component, where a variety of alignment components may be provided to offer different tempos, for example, and be available for a given reference file. It should also be appreciated that, in some embodiments, the reference file can comprise the alignment component, or the alignment component can be a file separate from the reference file.

The alignment component can be used to synchronize the virtual performer with the reference file, for example, at the start of the reference, after the start of the reference file, during any portion of the reference file, at the end of the reference file, or during the entire reference file. The virtual performer, or the reviewer of the virtual performance, can use the alignment component to integrate, or compile, the virtual performance with the reference track, transforming the virtual performance into a derivative performance of the reference file, in some embodiments. The alignment component can be used as described herein to compile the virtual performance with a file other than the reference track, in some embodiments. Moreover, the alignment component can also be used to automate the compiling of the virtual performance with any other audio file that is operable with the alignment component.

The alignment component can facilitate a use of sight, sound, or touch senses to assist the virtual performer, or reviewer, in the alignment of the virtual performance with, for example, the reference file. And, in some embodiments, the alignment component can use a combination of the senses. For example, the alignment component can be an audible alignment tool, such as an audible metronome track, which can be referred to as a “click track” in some embodiments. It should also be appreciated that the reference file can comprise a click track stem; or, the click track can be an independent file, separate from the reference file. And, the click track can be combined with one or more of the plurality of tracks in the reference file.

The alignment component may also be visual, implementing markings or lighting from a display screen to assist the virtual performer, for example, in the alignment of the audio tracks in the creation of a virtual performance. In some embodiments, the alignment component can provide both audible sounds and visible indicia. And, it should be appreciated that an audio track can be a wave file that can be synchronized in other ways, such as through the use of mathematical algorithms that can graphically characterize the audio tracks for matching with other audio tracks, for example. Graphical displays may include any graphical data interpretation known to one of skill including, but not limited to, matching wave forms on a graphical display and/or providing a numerical display that indicates a relative degree of integration, to assist in such an alignment of audio tracks. In some embodiments, the process of implementing the alignment component can be automated.

The virtual submissions can be random or non-random. As such, the methods can also include providing the reference file to random, virtual performers over a network. In some embodiments, the term “random” can be used herein, for example, to merely distinguish from the term “select,” where a “select” virtual performer can be a performer that has provided a winning submission selected from among the group of random, virtual performers; and, as a result, belongs to a defined group of submissions, has been reviewed by a reviewer, and has been chosen as a select, virtual performer. A random virtual performer, on the other hand, may include any virtual performer worldwide, nationwide, statewide, citywide, from within a group of organizations, or from within a single organization, that provides a submission of a virtual performance for review according to some embodiments taught herein.

In some embodiments, the random, virtual performer can provide a submission in response to a general, public offering of an opportunity for such performers to enter a submission for review. In some embodiments, the random, virtual performer can provide a submission in response to a limited, public offering of an opportunity for such performers to enter a submission for review. A limited public offering may include, for example, an offering to less than all of the persons from a population worldwide, nationwide, statewide, citywide, from within a group of organizations, or from within a single organization. In some embodiments, the virtual performer is a random, virtual performer even if (i) the performer is a member of an organization that implements a method taught herein, (ii) the performer has paid to be a member of the organization, and/or (iii) the performer was in fact selected to be a member of the organization. The limited public offering can also be an offering targeted to specific geographic regions for example, and such an offering can still be considered a random offering. The limited public offering can also be an offering targeted to particular artists, in which event, the offering becomes non-random. In fact, an offering can also include a private offering, targeted to particular artists, again non-random, the information regarding which is not made available on a general, or even limited, public basis. In these embodiments, a private offering can be less than a mass scale or can expand to be considered a mass scale, private offering in some embodiments.

The term “network” can include, for example, any interconnected system of things or people. In some embodiments, a network includes a computer network, and the network can be an internet or intranet system. As such, the network can provide an internet portal for public submissions of virtual performances, in some embodiments. As such, it should be appreciated that a network can include a public venue, such as a broadcasting venue including, but not limited to, television, radio, or satellite broadcasting systems. In some embodiments, the public venue includes a distribution component in the chain of commerce, services, or education including, but not limited to, consumer-facing websites; a retail store, or a chain of retail stores in a franchise; an entertainment venue, or a chain of entertainment venues in a franchise; an educational institution, or a chain of educational institutions; and the like. In some embodiments, the network is accessible through a handheld wireless device. The public venue can be provided by a network or coupled to a network, such that the public venue itself can run the network or can merely couple to the network to practice the methods taught herein.

The method can also include developing a derivative, multi-track musical work having a select, virtual performance from the public. The developing can include obtaining a set of random, virtual performances from the random, virtual performers, each virtual performance in the set comprising a derivative track having a virtual performer performing the derivative track without an accompaniment of the reference file and in alignment with the alignment component. And, each virtual performance in the set can also comprise a reference-mix track having the virtual performer performing the derivative track with the accompaniment of the reference file.

It should be appreciated that the reference-mix track can be used in the reviewing process to assist the reviewer in selecting a virtual performer. The reference-mix track allows the reviewer to hear how the virtual performance sounds when accompanied by the reference file, for example, in some embodiments. In some embodiments, the virtual performer is accompanied by all stems in the reference file and, in some embodiments, the virtual performer can be accompanied by less than all stems in the reference file, for example, where an artist is selective and chooses a reference-mix that includes less than all stems in the reference file.

The methods taught herein can also include choosing the select, virtual performance from the set of random, virtual performances; and, transforming the select, virtual performance into the derivative, multi-track musical work. In some embodiments, the term “transforming” can include any data manipulation that transforms the data present in the select, virtual performance into a musical work having a compilation of the select, virtual performance with a different audio track or set of audio tracks. In some embodiments, the transforming includes an integration, or compiling, of the select, virtual performance with at least the reference file. And, in some embodiments, a plurality of select, virtual performances are compiled, where the select virtual performances can be compiled into a musical work with or without an integration of the reference file.

In some embodiments, the artistic work can comprise an original expression, a derivative expression, or both. In some embodiments, the integration or compilation of audio tracks creates a derivative, multi-track musical work. In some embodiments, the virtual performances are not auditions for an ongoing position in the market, such as an audition for a position in a band, for example. In some embodiments, however, the virtual performance can be used as an audition, in a traditional sense, where the select, virtual performer is chosen, for example, to regularly contribute to a musical group in a traditional, real-time physical setting. Moreover, a virtual performance can comprise an individual performance, such that the virtual performer consists of a single performer; or, a group performance, such that the virtual performer consists of a plurality of performers.

The teachings provided herein can include providing an element of guidance to the virtual performer in recognition that guidance in the compilation of audio tracks is a functional element that has been traditionally and successfully used in the creation of a quality musical work. It should be appreciated that, without such guidance, developing a musical work can be difficult-to-impossible, and the quality of a musical compilation can generally be expected to suffer tremendously, to the extent of being a failed compilation. The guidance can be a generalized form of guidance for all virtual performances; customized for each offering in a set of offerings to virtual performers; or, a guidance that contains private information for a particular offering to non-random virtual performers, for example. In some embodiments, the guidance can be professional guidance from a person of ordinary skill in the art of making musical compilations; or, the guidance can also be professional guidance from a person of exceptional skill, and perhaps even notoriety, in the art of making musical compilations. The providing of the reference file to a virtual performer, for example, can include instructing the virtual performers in how to meet a criteria desired for the select, virtual performance.

In some embodiments, the criteria may include any criteria desired in a particular offering such as, for example, advice on a selection of tempos, tempo mapping, style, “mood or feel,” genre, physical appearance, or the like, in an effort to help meet criteria that may be desired by the reviewer. For example, the criteria may identify the desired musical style as belonging to a particular category and type of music that can be distinguished from other types of music and described to the virtual performer. The guidance on the criteria can clarify confusions or misinterpretations, since a simplified description, of a genre for example, can often be arbitrary, controversial, and perhaps too closely related to other genre. Since it's difficult-to-impossible to generically classify music in any logically consistent way, a simple description without guidance can generally be expected to lack in usefulness to the virtual performer and likely result in mismatched styles or misdirected virtual performances. Without proper guidance in the virtual performance, an artist and, particularly, an exceptional artist may be overlooked by the reviewer due simply to a lack of guidance. Likewise, even if the criteria is well understood and performed by an artist, a lack of sufficient guidance may still result in technical complications that exclude a virtual performance from a proper review. Such technical complications are well understood by those skilled in the art of compiling audio tracks to form musical works and include, but are not limited to, an improper audio level, lack of synchronization with the reference file.

Although ultimately suitable for all types of music, the teachings provided herein can be particularly well-suited for use with music that relies heavily on methods of production that include multi-tracked, overdubbed, non-simultaneous performances. Examples of such music types include, but are not limited to, pop, rock, country, hip hop, electronic, and dance. The use of multi-track procedures adds exceptional versatility and applicability over other known methods of screening talent when combined with the methods taught herein. The piece-wise assembly process for such music makes it particularly well-suited for use with the present teachings. Genres of music whose recording production process involves live, simultaneous performance of a group or ensemble as a defining characteristic includes, but is not limited to classical, jazz, blues, choirs, folk,

Rock and country are very well suited for the methods taught herein and can be considered unique, for example, at least with regard to their non-live, non-simultaneous performance recording processes. The result is a master recording that is made to sound as if it was performed live and simultaneously by a band. As such, rock music is multi-track in its compilation, as well as by consumer expectation.

The teachings are also directed to a virtual recording studio. In these embodiments, the virtual recording studio can comprise, for example, components that include an offering module, an instruction module, an input device, a music database, a subject-profile module, a solutions module, an integration engine, and a graphical user interface.

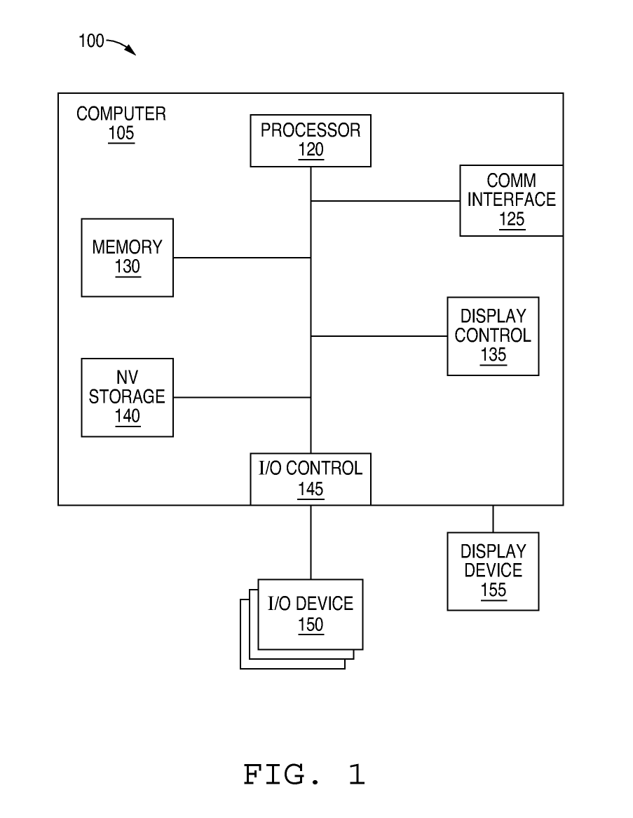

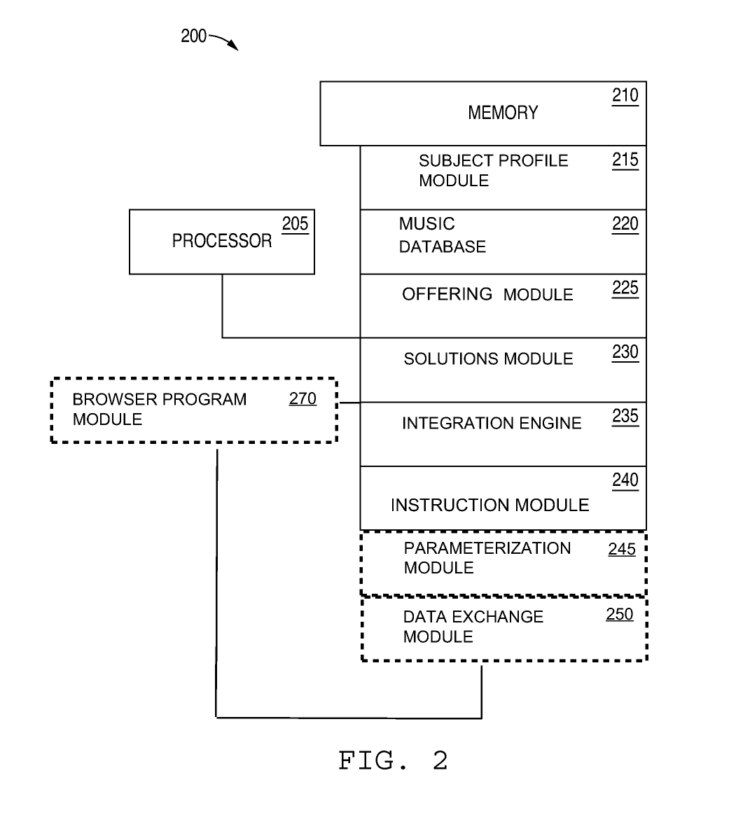

FIG. 1 shows a general technology platform for a virtual studio, according to some embodiments. The computer system 100 may be a conventional computer system and includes a computer 105, I/O devices 110, and a display device 115. The computer 105 can include a processor 120, a communications interface 125, memory 130, display controller 135, non-volatile storage 140, and I/O controller 145. The computer system 100 may be coupled to or include the I/O devices 150 and display device 155.

The computer 105 interfaces to external systems through the communications interface 125, which may include a modem or network interface. It will be appreciated that the communications interface 125 can be considered to be part of the computer system 100 or a part of the computer 105. The communications interface 125 can be an analog modem, isdn modem, cable modem, token ring interface, satellite transmission interface (e.g. “direct PC”), or other interfaces for coupling the computer system 100 to other computer systems. In a cellular telephone, this interface is typically a radio interface for communication with a cellular network and may also include some form of cabled interface for use with an immediately available personal computer. In a two-way pager, the communications interface 125 is typically a radio interface for communication with a data transmission network but may similarly include a cabled or cradled interface as well. In a personal digital assistant, for example, the communications interface 125 typically can include a cradled or cabled interface and may also include some form of radio interface, such as a BLUETOOTH or 802.11 interface, or a cellular radio interface.

The processor 120 may be, for example, a conventional microprocessor such as an Intel Pentium microprocessor or Motorola power PC microprocessor, a Texas Instruments digital signal processor, or a combination of such components. The memory 130 is coupled to the processor 120 by a bus. The memory 130 can be dynamic random access memory (DRAM) and can also include static ram (SRAM). The bus couples the processor 120 to the memory 130, also to the non-volatile storage 140, to the display controller 135, and to the I/O controller 145.

The I/O devices 150 can include a keyboard, disk drives, printers, a scanner, and other input and output devices, including a mouse or other pointing device. The display controller 136 may control in the conventional manner a display on the display device 155, which can be, for example, a cathode ray tube (CRT) or liquid crystal display (LCD). The display controller 135 and the I/O controller 145 can be implemented with conventional well known technology, meaning that they may be integrated together, for example.

The non-volatile storage 140 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 130 during execution of software in the computer 105. One of skill in the art will immediately recognize that the terms “machine-readable medium,” “computer-readable storage medium,” or “computer-readable medium” includes any type of storage device that is accessible by the processor 120 and also encompasses a carrier wave that encodes a data signal. Objects, methods, inline caches, cache states and other object-oriented components may be stored in the non-volatile storage 140, or written into memory 130 during execution of, for example, an object-oriented software program. In some embodiments, these media can include modules or engines, for example, in which the modules or engines are complete, in that they can include the software, hardware, software/hardware combinations, and any other components recognized by one of skill that enable their operability in their functions as taught herein.

The computer system 100 is one example of many possible different architectures. For example, personal computers based on an Intel microprocessor often have multiple buses, one of which can be an I/O bus for the peripherals and one that directly connects the processor 120 and the memory 130 (often referred to as a memory bus). The buses are connected together through bridge components that perform any necessary translation due to differing bus protocols.

In addition, the computer system 100 is controlled by operating system software which includes a file management system, such as a disk operating system, which is part of the operating system software. One example of an operating system software with its associated file management system software is the family of operating systems known as Windows CEO and Windows® from Microsoft Corporation of Redmond, Wash., and their associated file management systems. Another example of operating system software with its associated file management system software is the LINUX operating system and its associated file management system. Another example of an operating system software with its associated file management system software is the PALM operating system and its associated file management system. The file management system is typically stored in the non-volatile storage 140 and causes the processor 120 to execute the various acts required by the operating system to input and output data and to store data in memory, including storing files on the non-volatile storage 140. Other operating systems may be provided by makers of devices, and those operating systems typically will have device-specific features which are not part of similar operating systems on similar devices. Similarly, WinCE® or PALM operating systems may be adapted to specific devices for specific device capabilities.

The computer system 100 may be integrated onto a single chip or set of chips in some embodiments, and typically is fitted into a small form factor for use as a personal device. Thus, it is not uncommon for a processor, bus, onboard memory, and display/I/O controllers to all be integrated onto a single chip. Alternatively, functions may be split into several chips with point-to-point interconnection, causing the bus to be logically apparent but not physically obvious from inspection of either the actual device or related schematics.

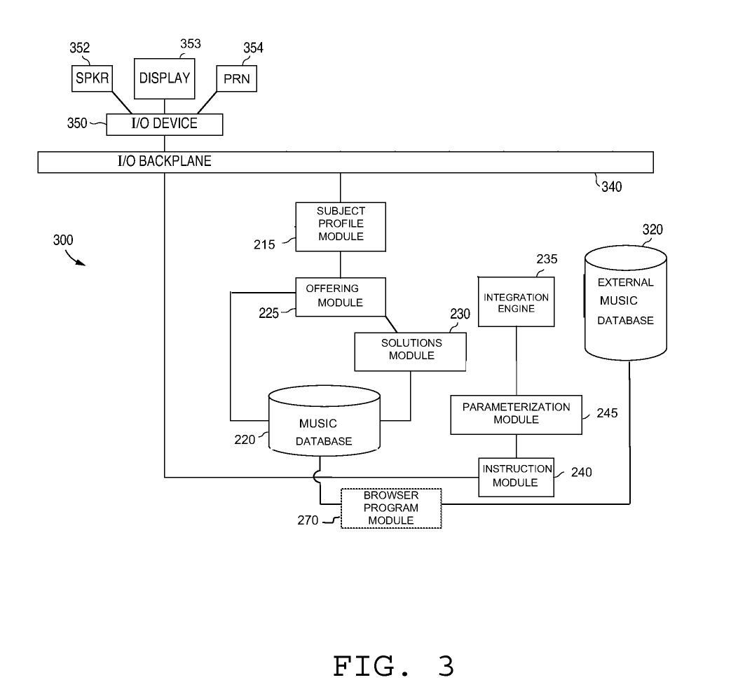

FIG. 2 illustrates a processor-memory diagram to describe components of a virtual studio, according to some embodiments. The system 200 shown in FIG. 2 can include, for example, a processor 205 and a memory 210 (that can include non-volatile memory), wherein the memory 210 includes a subject-profile module 215, a music database 220, an offering module 225, a solutions module 230, an integration engine 235, and a instruction module 240. And, as shown in the figure, other components can be included.

The system includes an input device (not shown) operable to allow a user to enter a personalized subject-profile into the computing system. Examples of input devices include a keyboard, a mouse, a data exchange module operable to interact with external data formats, voice-recognition software, a hand-held device in communication with the system, and the like.

The offering module 225 can be embodied in a computer readable storage medium and operable for offering an opportunity to provide a submission of a random, virtual performance to a popular artist through a public venue. The offering can include an association with the goodwill of the popular artist through the creation of a musical work with the popular artist if chosen as a select, virtual performer.

The instruction module 240 can be embodied in a computer readable storage medium and operable for providing virtual instruction to the user regarding a criteria for making a random, virtual submission through the public venue.

The music database 220 can be embodied in a computer readable storage medium and operable to store a library of music comprising reference files for multi-track, musical works.

The subject-profile module 215 can be embodied in a computer readable storage medium and operable for receiving the personalized subject-profile and converting the personalized subject profile into a virtual performer profile. The virtual performer profile can comprise a virtual performance from the user and can include an identification of a select artist, a reference file for a select, multi-track musical work having an alignment component; a derivative track created by the user; and, a reference-mix track created by the user. The input device can allow a user to enter a personalized subject-profile into a computing system. And, the personalized subject-profile can comprise a questionnaire designed to obtain information to be used to produce a personalized file for the user.

The solutions module 230 can be embodied in a computer readable storage medium and operable for parsing music in the music database into audio track stems in response to the user's selection of the artist and the reference file. The integration engine 235 can be embodied in a computer readable storage medium and operable for compiling the derivative track with the reference file using the alignment component.

It should be appreciated that any of the modules or engines can have additional functions and additional modules and engines can also be added to provide even more functionality. The integration engine 235 can also be used for identifying flaws in the derivative track for rejecting the random, virtual performance as an automated pre-screening. Of course, the studio will have a processor 205. And, the graphical user interface (not shown) can be used for displaying video, audio, and/or text to the user.

The “flaws” can be referred to, in some embodiments, as technical or preferential reason that a particular audio track may fall outside of a desired criteria. A pre-screening process can be used to reduce a high number of submissions down to a practical number for review and, in some embodiments, the criteria can be widened or narrowed to harness a desired number of submissions. The pre-secreening process can be a relatively simple function or, in some embodiments, it can be a relatively complex function. It should be appreciated that the value of pre-screening cannot be overstated, as reviewing a high number of audio files, particularly on a mass scale, can be daunting for a human reviewer practicing traditional music production techniques. And, most would agree that having a human reviewer would be most desirable, as the reviewing and selecting of artistic skill and quality brings in a host of “human” criteria, often quite subjective to a particular genre or a reviewer, that would be difficult-to-impossible to capture and automate with a machine. Accordingly, an automated pre-screening of such works to remove works through an automatable criteria, works outside of the desired “human” criteria, for example, could assist in making the mass screenings of artistic works practical, and quite possible, for a human reviewer.

In some embodiments, the artistic work subject to pre-screening can include any work considered a copyrightable expression. For example, a musical expression can be pre-screened for a variety of musical criteria, such as tuning, pitch, transients, or other patterns, that can be used as a general screening technique, programmable to remove works that fall outside of the desired criteria. And, as described herein, the criteria can be any desired criteria. The pre-screening, for example, can use waveforms, sound levels, patterns, and the like, which can be graphically identified or numerically identified. In some embodiments, a vocalist, for example, could have repeated issues with tuning and pitch that drop the quality rating of the vocalist below a threshold normally considered acceptable for continued screening. The establishment of such a criteria may, for example, remove a substantial percentage of submissions from the review process, saving the human reviewer greatly in time and resources.

In some embodiments, any one or any combination of the following can be used for screening virtual performances in the filtering of a large number of submissions, particularly mass submissions: (i) a standard of technical acceptability involving, for example, proper synchronization, sound quality, audio level, or a combination thereof; and, (ii) an Artist/Reviewer specification including, for example, an instruction set that is defined by the Artist/Reviewer containing, for example, variable tolerances for: pitch/tuning, timing/rhythmic accuracy, note selection (pre-determined scale/ key), tone/timbre, or a combination thereof. An example of some technical considerations that can be used to pre-screen submissions include, but are not limited to, technical complications, such as 1) sound level (too high or too low); 2) synchronization (audio does not play back with corresponding audio tracks; 3) sample rate/pitch/playback speed that would also prevent the track from being eligible for use; and 4) sound quality (distortion, high noise floor, interference). Some preferential considerations may include, but are not limited to, other issues, such as 1) key of the song; 2) chord progression/chord changes; 3) arrangement (order of the parts of the song, e.g. chorus, verse, bridge, etc.); 4) time signature; 5) intonation (poorly tuning instrument); 6) tone (timbre of the instrument); and, 7) performance (level of proficiency, timing, level of precision).

In some embodiments, the system further comprises a parameterization module operable 245 to derive select parameters such as, for example, display-preference parameters from the user profile, and the graphical user interface displays select data from the music database 220 in accordance with the user's display preferences and in the form of the customized set of information subset options. Select parameters may include user selections, administrator selections, or some combination thereof. For example, the user may prefer a select combination of shapes, colors, sound, and any other of a variety of screen displays and multimedia options. Furthermore, the selections can be used to personalize and change the display-preference parameters easily and at any time.

In some embodiments, the system further comprises a data exchange module 250 operable to interact with external data formats, wherein the subject-profile comprises external musical data obtained from another database or source, such as a remote memory source, including any external memory or file known to one of skill.

In some embodiments, the system further comprises a messaging module (not shown) operable to allow users to communicate with other users having like subject-profiles, or others users in a profile independent manner, merely upon election of the user. The users can email one another, post blogs, or have instant messaging capability for real-time communications. In some embodiments, the users have video and audio capability in the communications, wherein the system implements data streaming methods known to those of skill in the art.

The systems taught herein can be practiced with a variety of system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network. As such, in some embodiments, the system further comprises an external computer connection and a browser program module 270. The browser program module 270 can be operable to access external data through the external computer connection.

FIG. 3 is a concept diagram illustrating the virtual studio, according to some embodiments. The system 300 contains components that can be used in a typical embodiment. In addition to the subject-profile module 215, music database 220, the offering module 225, the solutions module 230, the integration engine 235, and the instruction module 240 shown in FIG. 2, the memory 210 of the device 300 also includes parameterization module 245 and the browser program module 270 for accessing the external music database 320. The system can include a speaker 352, display 353, and a printer 354 connected directly or through I/O device 350 connected to I/O backplane 340.

It should be appreciated that, in some embodiments, the system can be implemented in a stand-alone device, rather than a computer system or network, such that the device functions as a virtual studio as provided herein, but does not perform any other substantially different functions. In figure FIG. 3, for example, the I/O device 350 connects to the speaker (spkr) 352, display 353, and microphone (mic) 354, but could also be coupled to other features. Other features can be added such as, for example, an on/off button, a start button, an ear phone input, and the like. In some embodiments, the system can turn on and off through motion.

In some embodiments, the studio can include security measures to protect the user's privacy, integrity of data, or both. And, the studio can further comprise a response module embodied in a computer readable storage medium for matching the virtual performer profile with the automated pre-screening to provide an automated status report to the user.

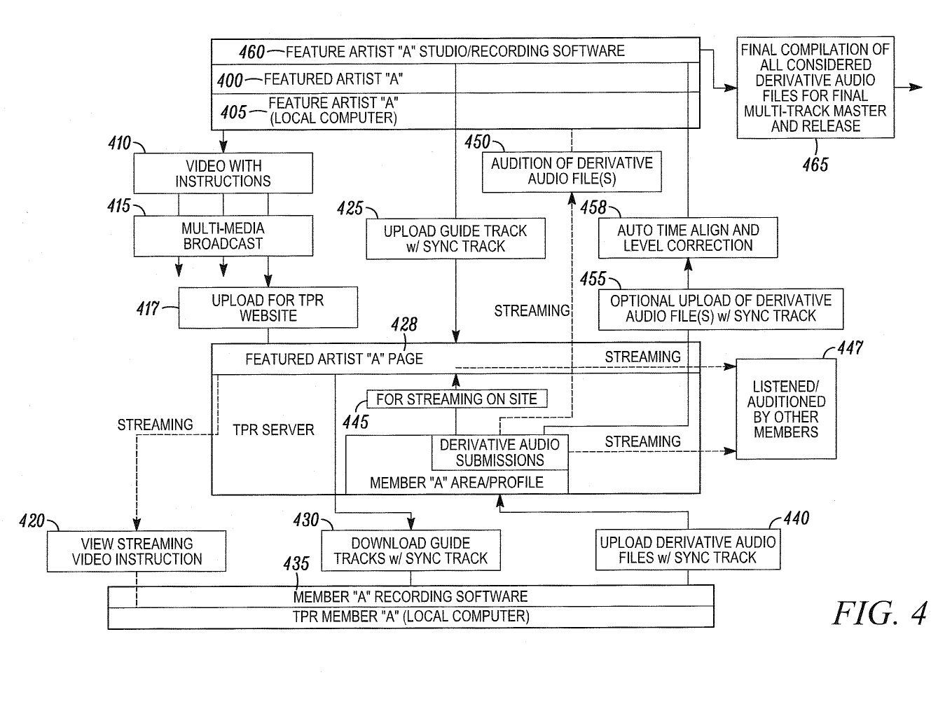

FIG. 4 illustrates the studio from the perspective of a featured artist offering an opportunity for random, virtual performers to submit virtual performances for inclusion in a derivative, multi-track musical work through a primary server, according to some embodiments. Featured artists 400, or their administrator can post a video 417(or broadcast via TV, satellite or wireless 415) with a set of specific instructions, which may include desired criteria for the virtual performance, explaining what is expected or desired of the members in the creation of their derivative audio submission.

In some embodiments, each of the featured artists can make guide tracks/stems available (along with a synchronization track) 425 for users to download from a primary server (e.g., the THE PUBLIC RECORD (TPR) server) that is specific and compartmentalized for each feature artist, which is called the featured artist page 428. It should be appreciated that the tracks/stems can be obtained from another source or database. In some embodiments, such tracks/stems are available from a remote server.

Members can access a featured artists page through a network server, for example, and download the guide tracks/stems (and synchronization track) to their local computer 430. Members may use recording software embedded on their local computer, or other software including, but not limited to, software that may be proprietary and licensed for use during the offering, to create (record) derivative individual audio files that pertain to the featured artists guide or stem tracks 435. Members can make and upload their derivative recording and synchronization track to the feature artist admin section for consideration into the final multi track master 440. A featured artist, or their administrator, can review each request 450 and decide whether to download 455 the submissions to a local workstation for potential inclusion to the final multi track master 460.

Each member's recordings can utilize a supplied synchronization track to define a reference indicia to align tracks where, for example, a starting point in the musical work can be used align the submissions to the artists guide tracks. The alignment can be manual, in some embodiments; or, the alignment can be automated for ease of review of submissions from mass offerings, for example.

Other review simplifications can be used to bring practicality into the review of submissions from mass offerings. For example, it should be appreciated that a substantial percentage of submissions may fall outside of the standards for an acceptable submission. Any set of standards may be used to reject submissions. In some embodiments, a system 458 can be used to automatically reject audio submissions for a variety of reasons, for example, where such submissions fall outside a predefined threshold level (typically—0.5 db, for example).

The system 458 may also send a notice to the submitter to request a correction within a specified time frame, for example, or possibly indicate that their submission has been rejected without an opportunity for cure. In these embodiments, for example, audio submissions below a predefined level threshold level (tyically—4 db, for example) can be automatically normalized within the system 458. After screening, review, and selection of an artist or artists, the featured artist, or their administrator, can make a final compilation of all considered parts for a final multi track master recording 465.

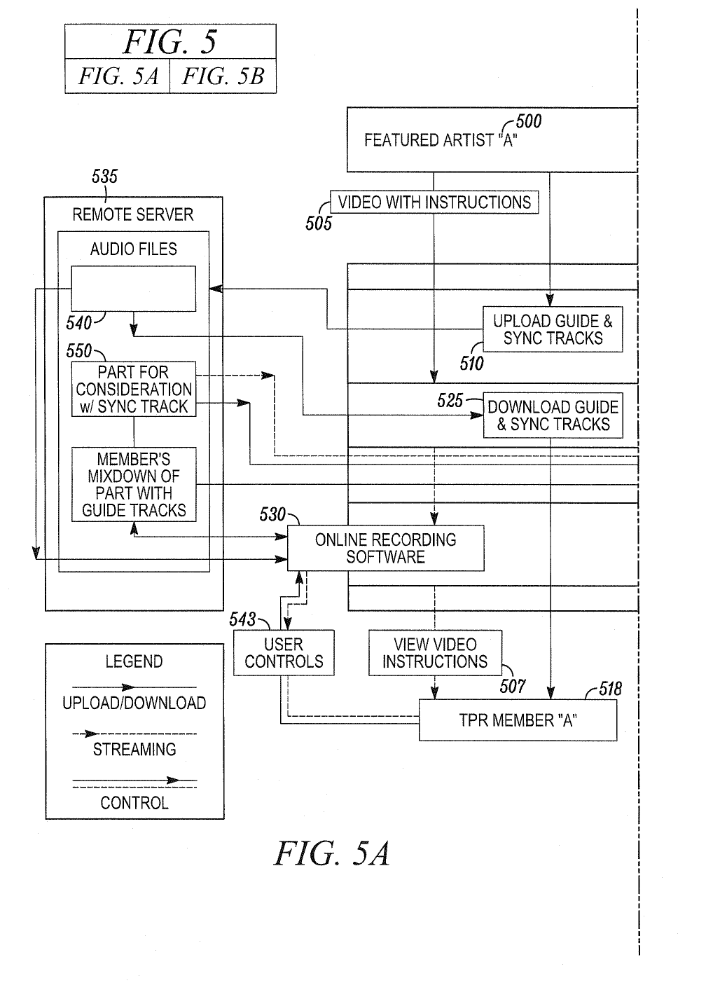

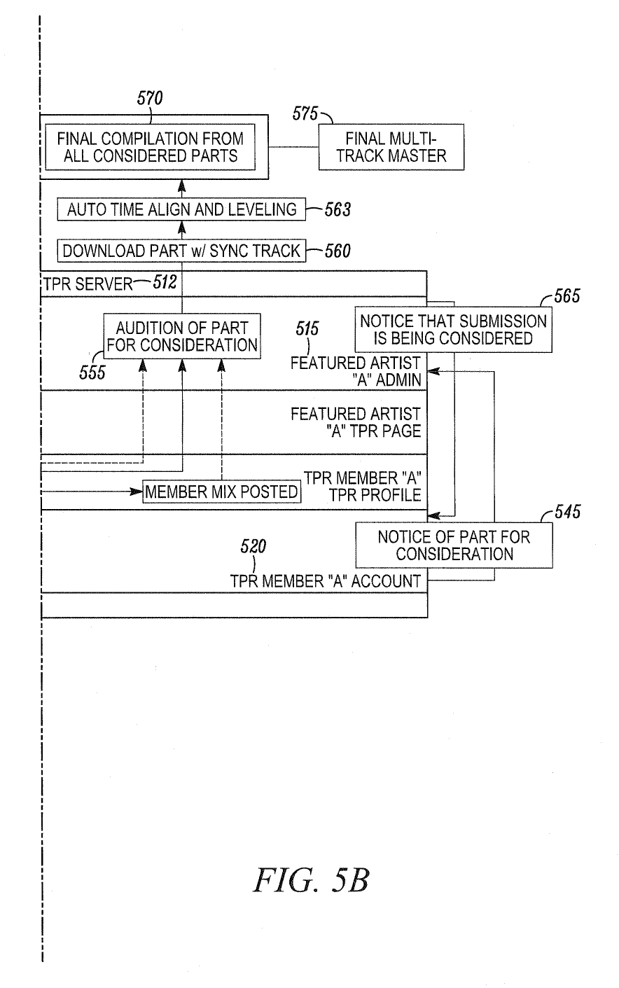

FIG. 5 illustrates the studio from the perspective of a featured artist offering an opportunity for random, virtual performers to submit virtual performances for inclusion in a derivative, multi-track musical work through a primary server in conjunction with a remote server, according to some embodiments. As described above, featured artists 500 can post a video 505 (or broadcast via TV, satellite or wireless) with a set of specific instructions explaining what is expected of the members 507 in the creation of their derivative audio submission.

In some embodiments, each of the featured artists can make guide tracks/stems available (along with a synchronization track) 510 for users to download from the primary server (e.g., the TPR server) that is specific and compartmentalized for each feature artist which is called the featured artist admin section 515.

Each member 518 can have a dedicated area on a server that is specific and compartmentalized for the member's account 520. Members can access the featured artists guide tracks/stems (and synchronization track) and move the files to their appropriate member account on the server.

Using the online recording software embedded in a website (e.g. the TPR website) 530, members can create (record) derivative individual audio files that pertain to the featured artists guide or stem tracks. Members may also use recording software embedded on their local computer, or other software including, but not limited to, software that may be proprietary and licensed for use during the offering, to create (record) derivative individual audio files that pertain to the featured artists guide or stem tracks.

In some embodiments, the online recording software can use a completely different server 535 to record and store the audio data 540 while the online recordng software will contain the pertinent regions that control 543 and point to that particular server.

Members can give notice to feature artist, or the artist's administrator 545 that he or she has created a part for consideration in the compilation on the final master and post the submission along with the synchronization track to the feature artist admin section for consideration into the final multi track master 550.

The featured artist, or their administrator, can review each request 555 and decide whether to move the considered part to the featured artist administrator section or download it to a local workstation 560 for potential inclusion to the final multi track master.

As described herein, a member's recordings utilize the supplied synchronization track to define a starting point that will automatically align the submissions to the artists guide tracks. In some embodiments, system 562 can automatically reject audio submissions above a predefined threshold level (typically—0.5 db, for example,) and sends a notice to the submitter while audio submissions below a predefined level threshold level (tyically—4 db, for example) are automatically normalized within the system 562.

In some embodiments, the member can receive notice 565 that the submission has been moved from their respective member area for further consideration for inclusion into the final multi track master. The notice can be personal or automated, in some embodiments. After rejection, review, and selection of an artist or artists, the featured artist, or their administrator, can make a final compilation 570 of all considered parts for a final multi track master recording 575.

The teachings are also directed to a method of creating public interest in a musical work. In these embodiments, the method can comprise creating a reference file for a musical work comprising a plurality of audio tracks, each of the plurality of audio tracks in alignment with an alignment component. In these embodiments, the method can include making a public offering of an opportunity for random, virtual performers to submit virtual performances for inclusion in a derivative, multi-track musical work containing a select, virtual performance. The offering can include providing the reference file to the random, virtual performers through a public venue.

In some embodiments, the public venue comprises a television broadcast, a radio broadcast, or a satellite broadcast. And, in some embodiments, the venue can be provided by a computer network, or be coupled to a computer network. Moreover, the venue can be accessible by a handheld wireless device, in some embodiments.

And, in some embodiments, the select, virtual performer can be given a consideration. The consideration, for example, can comprise an affiliation with the goodwill of a successful music industry professional, such as a popular artist in the creation of the musical work; a financial consideration; substantial exposure to key contacts in the musical industry; marketing contacts and channels; and the like.

The teachings are also directed to a method of creating a public interest in a musical artist through offering the public a virtual performance with a popular artist. In these embodiments, the method can comprise attracting random, musical performances on a mass scale from the public by offering the public an opportunity to provide a virtual, submission to a popular artist through a public venue. The term “mass scale” can refer to a high number of submissions obtained through an offering that is worldwide, nationwide, statewide, citywide, from within a group of organizations, or from within a single organization, should the group of persons be large enough to offer a mass scale. In some embodiments, a mass scale includes an offering that is made available to over 1000, 5,000, 10,000, 20,000, 40,000, 50,000, 100,000, 1,000,000, 2,000,000, 5,000,000, 10,000,000, 20,000,000, 100,000,000 or more persons, or any range therein. In some embodiments, a mass scale comprises an offering that is made over one or more clusters having over 5,000, 10,000, 20,000, 40,000, 50,000, 100,000, 1,000,000, 10,000,000, 100,000,000 or more servers, or any range therein, alone or in combination.

An offering in the teachings provided herein may include, for example, an association with the goodwill of a popular artist through the creation of a musical work with the popular artist if chosen as a select, virtual performer. An artist may be “popular” in a region that is worldwide, nationwide, statewide, citywide, from within a group of organizations, or from within a single organization. The term “popular” can refer to an individual, group, or other entity that is generally recognized and reputed among the region. An artist that is popular on a mass scale should be general recognized and reputed among the persons in the mass.

The teachings are also directed to a musical work. In these embodiments, the musical work can be a multi-track, derivative musical work including a select, virtual performance from a set of random, virtual performances from the public. The select, virtual performance can be obtained from a process including a review of musical performances on a mass scale from the public that were obtained by offering the public an opportunity to provide a virtual, submission to a popular artist through a public venue. In these embodiments, the offering can include an association with the goodwill of the popular artist through the creation of a musical work with the popular artist, if chosen as a select, virtual performer. The review can include a process comprising (i) obtaining a reference file for the musical work, the reference file comprising a plurality of audio tracks and an alignment component; and (ii) providing the reference file to random, virtual performers through the public venue. And, the multi-track, derivative musical work can be developed as described herein.

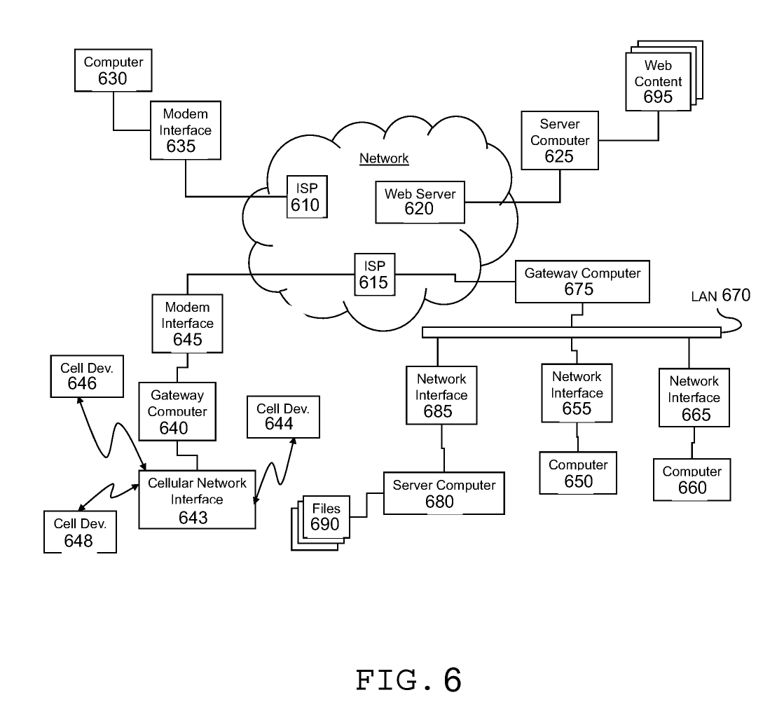

FIG. 6 shows how a network may be used for the virtual studio, in some embodiments. FIG. 6 shows several computer systems coupled together through a network 605, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 605 is typically provided by internet service providers (ISP), such as the ISPs 610 and 615. Users on client systems, such as client computer systems 630, 650, and 660 obtain access to the internet through the internet service providers, such as ISPs 610 and 615. Access to the internet allows users of the client computer systems to exchange information, receive and send e-mails, and view documents, such as documents which have been prepared in the HTML format, for example. These documents are often provided by web servers, such as web server 620 which is considered to be “on” the internet. Often these web servers are provided by the ISPs, such as ISP 610, although a computer system can be set up and connected to the internet without that system also being an ISP.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash, etc. In some embodiments, the system is compatible with Internet Browsers, such as Internet Explorer, Mozilla Firefox, Opera, Safari, etc. In some embodiments, the system is compatible with mobile devices having full HTTP/HTTPS support, such as IPHONE, POCKETPCs, MICROSOFT SURFACE, video gaming consoles, and the like. Others may include, for example, IPAD and ITOUCH devices. In some embodiments, the system can be accessed using a Wireless Application Protocol (WAP). This protocol will serve the non HTTP enabled mobile devices, such as Cell Phones, BLACKBERRY devices, etc., and provides a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on APPLE devices, Java or .Net-enabled platforms, etc. One of skill will appreciate that the system is not limited to any of the platforms discussed above and will be amenable to new platforms as they develop.

The web server 620 is typically at least one computer system which operates as a server computer system and is configured to operate with the protocols of the world wide web and is coupled to the internet. Optionally, the web server 620 can be part of an ISP which provides access to the internet for client systems. The web server 620 is shown coupled to the server computer system 625 which itself is coupled to web content 695, which can be considered a form of a media database. While two computer systems 620 and 625 are shown in FIG. 6, the web server system 620 and the server computer system 625 can be one computer system having different software components providing the web server functionality and the server functionality provided by the server computer system 625 which will be described further below.

Cellular network interface 643 provides an interface between a cellular network and corresponding cellular devices 644, 646 and 648 on one side, and network 605 on the other side. Thus cellular devices 644, 646 and 648, which may be personal devices including cellular telephones, two-way pagers, personal digital assistants or other similar devices, may connect with network 605 and exchange information such as email, content, or HTTP-formatted data, for example. Cellular network interface 643 is coupled to computer 640, which communicates with network 605 through modem interface 645. Computer 640 may be a personal computer, server computer or the like, and serves as a gateway. Thus, computer 640 may be similar to client computers 650 and 660 or to gateway computer 675, for example. Software or content may then be uploaded or downloaded through the connection provided by interface 643, computer 640 and modem 645.

Client computer systems 630, 650, and 660 can each, with the appropriate web browsing software, view HTML pages provided by the web server 620. The ISP 610 provides internet connectivity to the client computer system 630 through the modem interface 635 which can be considered part of the client computer system 630. The client computer system can be, for example, a personal computer system, a network computer, a web TV system, or other such computer system.

Similarly, the ISP 615 provides internet connectivity for client systems 650 and 660, although as shown in FIG. 6, the connections are not the same as for more directly connected computer systems. Client computer systems 650 and 660 are part of a LAN coupled through a gateway computer 675. While FIG. 6 shows the interfaces 635 and 645 as generically as a “modem,” each of these interfaces can be an analog modem, isdn modem, cable modem, satellite transmission interface (e.g. “direct PC”), or other interfaces for coupling a computer system to other computer systems.

Client computer systems 650 and 660 are coupled to a LAN 670 through network interfaces 655 and 665, which can be ethernet network or other network interfaces. The LAN 670 is also coupled to a gateway computer system 675 which can provide firewall and other internet related services for the local area network. This gateway computer system 675 is coupled to the ISP 615 to provide internet connectivity to the client computer systems 650 and 660. The gateway computer system 675 can be a conventional server computer system. Also, the web server system 620 can be a conventional server computer system.

Alternatively, a server computer system 680 can be directly coupled to the LAN 670 through a network interface 685 to provide files 690 and other services to the clients 650, 660, without the need to connect to the internet through the gateway system 675.

Through the use of such a network, for example, the system can also provide an element of social networking, whereby users can contact other users having similar subject-profiles, or user can contact anyone in the public to forward the personalized information. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device.

Regardless of the information presented, the system exemplifies the broader concept of an artistic information pool, as any form of art can be the subject of the studio. The system can integrate vast amounts of artistic information derived from one or more sources into a personalized presentation of information, regardless of the content of the information—any copyrightable expression, for example, can be the subject of the studio. The system can also organize information for individuals in a multi step fashion, displaying the information in easy to understand formats, and then optimizing the information so that various sub topics are personalized and interrelated.

The information can be presented in one set or parsed into multiple sets in a first layer of an information hierarchy. Information, for example, can be gathered on a subject of interest in the marketplace of the artist, using previously arranged templated questionnaires, answers to which populate a response pool. Such questionnaires can be, for example, demographics, survey activity, and other questions common in a particular art. Some response may also trigger more questionnaires. The user can also customize the system, such as choosing interfaces, colors, language, notifications, etc.

The system can enhances learning in a particular art by layering information into sets and subsets, such that the information is easier to assimilate as manageable subparts. The user is allowed to enter preferences into the system in order to customize visual displays that present the information the user in a personalized way. And, the system can also enhance learning by providing stimulating information, exclusive to the virtual studio, that would have otherwise been undiscovered by the user through conventional information gathering techniques. The system can enhance learning by providing a perceptual motor experience, and can provide a multimedia interaction for the user rather than simply providing information on a single medium, such as a display that is limited to a text display, or perhaps just a diagram or picture. In some embodiments, the multimedia interaction includes one or more of text and video; sound and diagrams, pictures, or images; sound; and video.

The system and its information database can also include any of a variety of system libraries that contain organized sets of any of a variety of information of value to users, in some embodiments. Moreover, information can be obtained from external data sources, whereby plug-ins and APIs can be designed to allow integration with third party systems and exchange data with external data sources. The external data sources can be used to provide information on demand, to update existing information stored in the system libraries, or both.

In some embodiments, the system contains an engine operable to create and optimize content for users. The engine can integrate information from other modules, as well as human inputs, e.g. from administrators and user interactions, and produces an optimized presentation for the user. In some embodiments, the engine can learn about the user through continued use, wherein the data collection algorithms and methods are modified to correlate with, for example, a user's types and frequencies of choices and answers. Relationships between the choices and answers can be structured to match the subject-profile, in some embodiments. In these embodiments, the engine starts with proprietary generic rules and algorithms, and these rules and algorithms continue to be refined as the system collects information and learns from the user and his/her interactions. Accordingly, the studio can have the capability of providing a unique insight to marketing data.

Some portions of the teachings are presented in terms of operations of the system. The operations are those requiring physical manipulations, transformations of matter, of physical quantities resulting in a useful product being produced. Usually, though not necessarily, these quantities take the form of data capable of being stored, transferred, combined, compared, and otherwise manipulated. It has proven convenient at times, principally for reasons of common usage, to refer to these signals as bits, values, elements, symbols, characters, terms, numbers, or the like. All of these and similar terms are to be associated with the appropriate physical quantities and are merely convenient labels applied to these quantities. Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover, the teachings relate to a system for performing the operations herein. This system may be specially constructed as an apparatus designed solely for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. It should be appreciated, however, the teachings include computing in a cloud environment where part, if not all, of the media and applications are available in the cloud and are merely accessed by the user from a remote location or device. Likewise, all or part of the media and applications can be obtained as files that operate independent of an internet bandwidth or cloud system, for example, and operated remotely, privately, and locally by the user or the reviewer.

It should be also appreciated that the methods and displays presented herein, in some embodiments, are not inherently related to any particular computer or other apparatus, unless otherwise noted. Various general purpose systems may be used with programs in accordance with the teachings herein, or it may prove convenient to construct a specialized apparatus to perform the methods of some embodiments. The required structure for a variety of these systems will be apparent to one of skill given the teachings herein. In addition, the techniques are not described with reference to any particular programming language, and various embodiments may thus be implemented using a variety of programming languages. Accordingly, the terms and examples provided above are illustrative only and not intended to be limiting; and, the term “embodiment,” as used herein, means an embodiment that serves to illustrate by way of example and not limitation. The following examples are illustrative of the uses of the present invention. It should be appreciated that the examples are for purposes of illustration and are not to be construed as limiting to the invention.

### EXAMPLE 1

### Production of a Derivative, Multi-Track Musical Work That Includes a Select, Virtual Performance From the Public

First, we attracted potential contributors by creating an internet forum, www.thepublicrecord.com (website for THE PUBLIC RECORD (TPR)). We provided a “reference file” to each potential contributor from a popular artist, an original musical work by Tommy Lee and Methods of Mayhem, that the submitter can play along with to create a derivative track. Participants made a user reference mix track that combines the artist reference file with the participants derivative track. The user reference mix was submitted to www.thepublicrecord.com (the TPR website) along with the isolated user derivative track.

We received approximately 10,000 submissions from submitters worldwide. Each participant submitted 2 or more files including a user's reference mix file and an isolated file. Of the approximately 10,000 submissions, we narrowed to 500 in the first cut. Of the 500, we narrowed to the top 100, taking the extra step of professionally compiling each of the isolated user files with the reference file to help us make selections. Ultimately, the selections were included in the derivative, multi-track musical work, a professionally mixed derivative of the original musical work by the popular artist. This work was the first recording of its kind in the history of music production.

It should be noted that the reference files provided to each submitter typically include 4 reference tracks (stems), such as drums, bass, guitar, and vocals. Any track, however, can be removed and any part can be played, as each track can be removed from the multi-track master recording in some embodiments. For example, the guitar track can be removed so that a virtual performer can play along as the lead guitar, without overlap with the original lead provided in the original reference file. Typically, all reference files are combined together in the download, however, a custom download may be available for some applications in which only part of the total set of stems is downloaded.

### EXAMPLE 2

### Addressing Technical Challenges Involved With Reviewing High Numbers of Virtual Submissions

World renowned artists have not made their unfinished tracks available to the general public on a massive scale to participate in the recording process for the creation of a multi-track master for commercial release. The technical problems associated with the process can make the procedure seemingly inoperable, problems that can be solved using at least the teachings provided herein.

The development and use of a method for continued creation of a multi-track recording utilizing an instruction set and unfinished audio tracks from a world-renowned popular artist and a network to obtain and screen a high number of virtual submissions presents a large number of administrative and technical problems. This is because the screening process can include considering several standards of technical acceptability (for proper synchronization, sound quality, and audio level), as well as an administrative criteria provided as a set of instructions by the Artist/Reviewer that may include variable tolerances for pitch/tuning, timing/rhythmic accuracy, note selection/pre-determined scale or key, and tone/timbre. These problems, if not resolved, were found to result in an inoperable process or, at the very least, an impractical process, particularly when the process is performed on a mass scale.

One problem, for example, involved synchronization, a step in the recording process that has been traditionally handled by professionals, real-time, in a recording studio. The solution required finding a way to synchronize audio files in the virtual environment, where interaction with an artist is not real-time. As such, a major technical challenge involved handling the synchronizing (tempo and start time) of the large number of audio submissions recorded submitted from many different platforms and software packages. A synchronization method was developed to provide the user with a downloadable tempo map along with the artists guide tracks (stems). As such, one embodiment handles the synchronization method by including the steps downloading guide tracks (stems) with a specific set of instructions that are broadcast through various mediums, and uploading user submissions that meet criteria by following the instructions.

A synchronization track was used, for example, such as a metronome track or “click track.” The synchronization track defined a reference point used to align the submissions to the artists guide tracks. The click track ran from the top to the bottom of the reference file provided by a featured artist.

The second technical challenge was in solving the problem of reducing the review time, as the high numbers of submissions combined with a need for a time-consuming human review can make the review process inoperable or, at the very least, impractical. Considering even the most normal distribution of submissions, a substantial percentage of unacceptable submissions can be expected. For example, differing audio levels of the submissions were found to present a problem in some submissions. An automatic system for rejecting audio submissions above a predefined threshold level (typically—0.5 db, for example) can be used to reduce the screening time. Such a system can also generate and send a notice to the submitter. Audio submissions below a predefined level threshold level (tyically—4 db, for example) are capable of automatic normalization within the system, and identification of such files by the automatic screening system can also reduce screening time.

### EXAMPLE 3

### Technical Guidance for Users

An aspect of the virtual studio that assists in making it operable on such a large scale, not to mention practical, is the guidance provided to the users. Technical guidance provided to the users in the operation of the system can allow for a successful process of receiving, reviewing, selecting, and transforming the select, virtual performance from the public into the derivative, multi-track musical work. And, the derivative work can be of a high professional quality, ready to market in the public domain. The following is an example of how the process may be implemented to users:

Watch the Public Offering:

Launch the TPR portal and select an artist from the featured artist display or featured artist menu. Once you are on the selected artists page watch the project overview video for detailed instructions and musical direction to determine if you are interested in participating.

If Interested in Participating:

Choose the menu item, tab or button, titled download guide tracks and hit the button on the appropriate song. You will now be prompted to fill out or the user download agreement and once you have agreed to the terms hit ok or submit.

Select the preferred file format that pertains to the multi-track audio software that you intend to use. Popular software titles include: DIGIDESIGN PROTOOLS, APPLE GARAGE BAND, RIFFWORKS, etc. Any of these software titles may provide you with a means to digitally record your audio performance on your local computer. Any of these titles, and more can be purchased at a variety of locations known to one skill, for example, see http://pro-audio.musiciansfriend.com/isoftware. Next, hit the appropriate download button to initiate the transfer of

a. the guide tracks/stems; and

b. click or metronome track (synch track). The click or metronome treack is always included with the guide tracks/stems. This is not an option and is necessary for inclusion in the users isolated or soloed upload submission to check synchronization; as well as,

c. the text file that contains other important information.

You have now downloaded the guide tracks/stems and the files will now reside in your download folder or any other folder that you've assigned in your browser download preferences on your local computer. On your local computer,

a. open your preferred multi track digital audio software as described above; and,

b. import the downloaded guide tracks/stems or pre formatted session.
i. If you have opened the pre formatted session, all of the guide tacks/stems and the click or metronome track (synch track) will now open in the software including song tempo information that will be imbedded in the file.

c. If you are setting up a new session in an unsupported file format and importing (i) the raw audio files and (ii) click or metronome track (synch track), refer to the attached text file for song tempo information and input this information into your software's set tempo option. Verify that the click or metronome track (synch track) is synchronizing with the software. This is achieved by turning on the software's metronome function and confirming that it is synchronized with the imported click or metronome track (synch track).
i. Highlight the click or metronome track (synch track) and using your on screen editing tool select the count off before the song starts and remove everything that follows. This will leave the user with only the count off derived from the original click or metronome track (synch track).

d. You should now have everything you need to begin the recording process on your local computer.

e. Record as many derivative tracks as you want (this is where you can record your ideas).

f. Once you have finished recording your derivative track, you can begin the upload and submission process:
i. Choose your preferred file format (e.g., mp3, way, aiff) and
ii. Export the user derivative track combined with the downloaded guide tracks/stems (user mix track). Use the export or bounce to disk feature to make a copy of the audio file (user mix track) on your local hard drive.
iii. Export the isolated user derivative track combined with the edited count off click or metronome track (synch track). Use the export or bounce to disk feature to make a copy of the audio file (user solo track) on your local hard drive. Repeat the following steps as necessary for all individual soloed derivative tracks.
iv. Launch the TPR portal and return to the featured artist page; and,
v. select the upload submission menu item, tab or button and choose audio.
vi. Fill out user upload agreement and hit ok or submit.
vii. Select the appropriate song from the pull down menu, and type a description of your submission in the field titled notes.
viii. Hit the browse button that pertains to the mixed track box and select your mixed audio track from your local computer and hit ok. Hit the browse button that pertains to the solo tracks box and select your solo audio files from your local computer and hit ok.
ix. Repeat as necessary for all additional soloed audio tracks. There is currently no limit as to the number of tracks you can submit.
x. After all files have been selected hit the upload button to complete your audio track submissions.

### EXAMPLE 4

### Technical Guidance for Reviewers

The reviewer may be, for example, a featured artist or a representative of the featured artist assigned to screen/audition/listen to and select the submitted derivative audio tracks. The reviewer may also utilize such selected tracks for inclusion into a master recording. The following is an example of how the process can be implemented for reviewers:

If Interested in Reviewing Submitted Tracks:

a. Launch the TPR portal, log into the Featured Artist profile that was previously created on their behalf by a TPR representative.

b. To enter the authorized administration area or portal the reviewer clicks on the My Account link that appears at the top of each page while they are logged in.

c. The “featured artist admin” is then selected which provides entry into the Administration Area or portal.

d. In order to review the submitted audio tracks, the featured artist would actuate the “review submissions” link.

Organizing/Sorting Submissions:

a) MASTER LISTING: A listing of all submitted derivative audio tracks is displayed and specifically indicates the submission ID#, user name, song title, submitter directions and notes, the time and date of submission.

b) CATEGORY LINKS: Additionally, this list can be sorted by user name, song title, instrument, and submission date and time. Each entry on the derivative audio submissions list has a link to review each of the two uploaded files (soloed derivative audio track with edited click/metronome/sync track and the mixed derivative audio track) independent from any third party multi-track digital audio software.

c) REVIEW TOOLS: While reviewing each of the mixed derivative audio tracks, the reviewer may indicate the state of each submission by designating one of the preset states: unknown, submitted (default), reviewed, chosen, rejected, or flagged. These distinctions of state are for administrative/reviewer reference only and are not viewable by the members or submitters on the TPR portal.

d) USER SORT: Multiple submissions in the list can also be sorted by grouping these user-defined distinctions together by clicking of the “states” heading at the top of the page.

Once all the submissions have been reviewed, and given a “state” designation, the review may elect to download selected derivative audio tracks for use outside of the TPR Artist Administrative Area/Portal.

a) Each favored submission can be selected via check box for preparation to be transferred from the TPR server to the reviewer's local computer. The selected derivative audio tracks that are automatically named in the upload process with submission number reference, song title and user name data, (along with the text of “solo” or “mixed” indicating its type of submission) will be copied to a compressed folder and downloaded to the reviewer's local computer downloads folder (or folder previously assigned to hold download data).

b) Additionally, the reviewer can delete any of the derivative audio tracks although it is not recommended to do so until the copy of the derivative audio tracks is confirmed or the project is complete.

Preview of Favored Submissions:

The submitters whose derivative audio tracks were initially selected can be highlighted by the reviewer in a video commenting on the quality of the submissions. This video can be posted for community viewing under the Daily Video tab on the media player present on the Featured Artist's TPR page.

Implementing Selected Submissions for Further Evaluation:

a) The downloaded files will now reside in your download folder or any other folder that you've assigned in your browser to download preferences on your local computer. The downloaded files are uncompressed and automatically copied into a duplicate uncompressed folder at a location designated by the reviewer. The selected derivative audio tracks of the soloed files are imported into the reviewer's digital audio multi-track software of his/her choice.

b) The imbedded edited click/metronome/reference at the beginning of each of the soloed derivative audio tracks will provide both visual and audible confirmation of positive synchronization so that the musical content recorded in the derivative audio track can be heard in context with other submitted soloed derivative audio tracks and pre-existing audio files that may be in the digital audio multi-track software.

Choice of Inclusion

a) The reviewer can take the time necessary to choose the appropriate derivative audio track or tracks that will be included into the final master mix of the song.

b) Multiple derivative audio tracks may be edited together, mixed together or combined to form a “composite” track or multiple composite tracks for inclusion into the master mix of the song.

Notification of Inclusion

a) Upon confirmation that the selected derivative audio tracks will be utilized in the final master recording, the reviewer may send each of the derivative audio track's submitters (whose user name is imbedded in the audio file name) notification that their submission was selected for inclusion into the final mix. This message can be sent via the TPR internal email system or using the member provided email address (that can be obtained from a TPR representative).

b) a video will be posted on the Featured Artist page announcing the official selection for mix inclusion to the TPR community and other linked social media sites.

### EXAMPLE 5

### Use of the Virtual Studio Through a Public Venue

The offerings and virtual submission can be internet based. However, it should be appreciated that other options can be used to reach the masses. A network can include, for example, another public venue, such as a broadcasting venue including, but not limited to, television, radio, satellite broadcasting systems, or a network of retail stores, whether brick-and-mortar or internet. The network could also be a college or university system, or an entertainment venue, such as a local bar, regional or franchise club, and the like, where virtual performances can be prepared, performed, and submitted. The following is an example of a television show that include the use of the virtual studio:

As described herein, regardless of the public venue, featured artists can use a primary server, such as the TPR server, as the virtual studio to review submitted audio tracks that are uploaded for consideration for a final multi-track master. Artists can select their favorite submissions and either download these files to assemble offline on their local computer's digital audio workstation, or they can use the embedded software on the TPR site to compile the audio tracks. Using either one of these options, the artist can select either the entire audio submission or specific sections to compile the final multi-track master.

Television, for example, could regain its status as an excellent public venue as a place to make an offering for submissions from the public, provide guidance to virtual performers, interview featured artists, as well as interview select, virtual performers, review and discuss submissions, and the like. One show may be called, for example, “TPR TV,” and could showcase famous artists, their works, and their select performers. The teachings herein discuss how the method can apply to virtually any expression, offering the opportunity for anyone to submit audio, video, photos or artwork through the TPR internet portal, for example. Viewers can follow famous artists in different genres, as they offer guidelines to the type of talent or participation that they are seeking.

In one series of episodes, a famous country star, for example, may present the opportunity for a virtual singer to record a duet with him, if selected as a select, virtual performer. The celebrity could outline the type of singer that he is seeking and drive participants to an internet portal, such as a host website, to download the audio file and participate. Participants could submit their performance for consideration into the TV show and ultimately the final commercial release of the song on the featured artists record. The TV show could highlight some of the most interesting or best submissions and the top finalists could, for example, be invited to the studio to record and/or be featured on the show as a finalist. The chosen singer would be featured in the final episode and on the commercial release of the song along-side the popular artist, providing massive exposure and goodwill to the select, virtual performer.

We claim:

1. A method of creating a derivative, multi-track musical work that includes a virtual performance from the public, the method comprising:
creating a reference file for a musical work comprising a plurality of audio tracks, each of the plurality of audio tracks in alignment with an alignment component;
providing the reference file to random, virtual performers over a network; and,
developing a derivative, multi-track musical work having a select, virtual performance from the public, the developing including
obtaining a set of random, virtual performances from the random, virtual performers, each virtual performance in the set comprising (i) a derivative track having a virtual performer performing the derivative track without an accompaniment of the reference file and in alignment with the alignment component; and, (ii) a reference-mix track having the virtual performer performing the derivative track with the accompaniment of the reference file
choosing the select, virtual performance from the set of random, virtual performances; and,
transforming the select, virtual performance into the derivative, multi-track musical work;
wherein,
the random, virtual performances are not real-time performances, as there is a delay between (iii) a transmitting of a random, virtual performance by the virtual performer to a reviewer and (iv) a reviewing of the virtual performance by the reviewer, the delay substantially exceeding a normal delay associated with the transmitting and receiving of a live audio transmission.

2. The method of claim 1, wherein the providing includes instructing the random, virtual performers in how to meet a criteria desired for the select, virtual performance.

3. The method of claim 1, wherein the alignment component comprises a metronome track.

4. The method of claim 1, wherein the network is accessible by a handheld wireless device.

5. The method of claim 1, wherein the set of random, virtual performances comprises an individual performance, such that the virtual performer consists of a single performer.

6. The method of claim 1, wherein the set of random, virtual performances comprises a group performance, such that the virtual performer consists of a plurality of performers.

7. A method of creating public interest in a musical work, the method comprising:
creating a reference file for a musical work comprising a plurality of audio tracks, each of the plurality of audio tracks in alignment with an alignment component;
making a public offering of an opportunity for random, virtual performers to submit virtual performances for inclusion in a derivative, multi-track musical work containing a select, virtual performance, the offering including providing the reference file to the random, virtual performers through a public venue, wherein the select, virtual performer is given a consideration; and,
developing the derivative, multi-track musical work, the developing including
obtaining a set of random, virtual performances from the random, virtual performers, each virtual performance in the set comprising (i) a derivative track having a virtual performer performing the derivative track without an accompaniment of the reference file and in alignment with the alignment component; and, (ii) a reference-mix track having the virtual performer performing the derivative track with the accompaniment of the reference file;
choosing the select, virtual performance from the set of random, virtual performances; and,
transforming the select, virtual performance into the derivative, multi-track musical work;
wherein,
the random, virtual performances are not real-time performances, as there is a delay between (iii) a transmitting of a random, virtual performance by the virtual performer to a reviewer and (iv) a reviewing of the virtual performance by the reviewer, the delay substantially exceeding a normal delay associated with the transmitting and receiving of a live audio transmission.

8. The method of claim 7, wherein the providing includes instructing the random, virtual performers in how to meet a criteria desired for the select, virtual performance.

9. The method of claim 7, wherein the alignment component comprises a metronome track.

10. The method of claim 7, wherein the venue comprises a television broadcast.

11. The method of claim 7, wherein the venue comprises a radio broadcast.

12. The method of claim 7, wherein the venue comprises a satellite broadcast.

13. The method of claim 7, wherein the venue is provided by a computer network.

14. The method of claim 7, wherein the venue is coupled to a computer network.

15. The method of claim 7, wherein the venue is accessible by a handheld wireless device.

16. The method of claim 7, wherein the consideration comprises an affiliation with the goodwill of a popular artist in the creation of the musical work.

17. The method of claim 7, wherein the set of random performances comprises an individual performance, such that the virtual performer consists of a single performer.

18. The method of claim 7, wherein the set of random performances comprises a group performance, such that the contributor consists of a plurality of performers.

19. A method of creating public interest in a musical artist through offering the public a virtual performance with a popular artist, the method comprising:
Attracting random, musical performances on a mass scale from the public by offering the public an opportunity to provide a virtual, submission to a popular artist through a public venue, the offering including an association with the goodwill of a popular artist through the creation of a musical work with the popular artist if chosen as a select, virtual performer;
obtaining a reference file for the musical work, wherein the reference file comprises a plurality of audio tracks, each of the plurality of audio tracks in alignment with an alignment component;
providing the reference file to random, virtual performers through the public venue; and, developing a derivative, multi-track musical work, the developing including
obtaining a set of random, virtual performances from the random, virtual performers, each virtual performance in the set comprising (i) a derivative track having a virtual performer performing the derivative track without an accompaniment of the reference file and in alignment with the alignment component; and, (ii) a reference-mix track having the virtual performer performing the derivative track with the accompaniment of the reference file;
choosing the select, virtual performance from the set of random, virtual performances; and,
transforming the select, virtual performance into the derivative, multi-track musical work;
wherein,
the random, virtual performances are not real-time performances, as there is a delay between (iii) a transmitting of a random, virtual performance by the virtual performer to a reviewer and (iv) a reviewing of the virtual performance by the reviewer, the delay substantially exceeding a normal delay associated with the transmitting and receiving of a live audio transmission.

20. The method of claim 19, wherein the providing includes instructing the random, virtual performers in how to meet a criteria desired for the select, virtual performance.

21. The method of claim 19, wherein the alignment component comprises a metronome track.

22. The method of claim 19, wherein the venue comprises a television broadcast.

23. The method of claim 19, wherein the venue comprises a radio broadcast.

24. The method of claim 19, wherein the venue comprises a satellite broadcast.

25. The method of claim 19, wherein the venue is provided by a network.

26. The method of claim 19, wherein the venue is coupled to a network.

27. The method of claim 19, wherein the venue is accessible by a handheld wireless device.

28. The method of claim 19, wherein the set of random performances comprises an individual performance, such that the select, virtual performer consists of a single performer.

29. The method of claim 19, wherein the set of random performances comprises a group performance, such that the select, virtual performer consists of a plurality of performers.

30. A virtual recording studio, comprising:
an offering module embodied in a computer readable storage medium and operable for offering an opportunity to provide a submission of a random, virtual performance to a popular artist through a public venue, the offering including an association with the goodwill of the popular artist through the creation of a musical work with the popular artist if chosen as a select, virtual performer;
an instruction module embodied in a computer readable storage medium and operable for providing virtual instruction to the user regarding a criteria for making a random, virtual submission through the public venue;
an input device to allow a user to enter a personalized subject-profile into a computing system, wherein the personalized subject-profile comprises a questionnaire designed to obtain information to be used to produce a personalized file for the user;
a music database embodied in a computer readable storage medium and operable to store a library of music comprising reference files for multi-track, musical works;
a subject-profile module embodied in a computer readable storage medium and operable for receiving the personalized subject-profile and converting the personalized subject profile into a virtual performer profile, wherein the virtual performer profile comprises a virtual performance from the user including an identification of a select artist, a reference file for a select, multi-track musical work having an alignment component; a derivative track created by the user, and, a reference-mix track created by the user;
a solutions module embodied in a computer readable storage medium and operable for parsing music in the music database into audio track stems in response to the user's selection of the artist and the reference file;
an integration engine embodied in a computer readable storage medium operable for compiling the derivative track with the reference file using the alignment component; and identifying flaws in the derivative track for rejecting the random, virtual performance as an automated pre-screening;
a processor; and,
a graphical user interface for displaying video, audio, and/or text to the user.

31. The studio of claim 30 further comprising security measures to protect the user's privacy, integrity of data, or both.

32. The studio of claim 30, wherein the alignment component comprises a metronome track.

33. The studio of claim 30, wherein the studio is provided by a network.

34. The studio of claim 30, wherein the studio is coupled to a network.

35. The studio of claim 30, wherein the studio is accessible through a handheld wireless device.

36. The studio of claim 30, wherein the studio further comprises a response module embodied in a computer readable storage medium for matching the virtual performer profile with the automated pre-screening to provide an automated status report to the user;

37. A musical work, comprising:
a multi-track, derivative musical work including a select, virtual performance from a set of random, virtual performances from the public; wherein,
the select, virtual performance was obtained from a process including a review of musical performances on a mass scale from the public that were obtained by offering the public an opportunity to provide a virtual, submission to a popular artist through a public venue, the offering including an association with the goodwill of the popular artist through the creation of a musical work with the popular artist if chosen as a select, virtual performer; wherein, the review includes a process comprising (i) obtaining a reference file for the musical work, the reference file comprising a plurality of audio tracks and an alignment component; and (ii) providing the reference file to random, virtual performers through the public venue;
the multi-track, derivative musical work is developed using a process that includes
obtaining a set of random, virtual performances from the random, virtual performers, each virtual performance in the set comprising (i) a derivative track having a virtual performer performing the derivative track without an accompaniment of the reference file; and, (ii) a reference-mix track having the virtual performer performing the derivative track with the accompaniment of the reference file;
choosing the select, virtual performance from the set of random, virtual performances; and,
transforming the select, virtual performance into the derivative, multi-track musical work;
and,
the random, virtual performances are not real-time performances, as there is a delay between (iii) a transmitting of a random, virtual performance by the virtual performer to a reviewer and (iv) a reviewing of the virtual performance by the reviewer, the delay substantially exceeding a normal delay associated with the transmitting and receiving of a live audio transmission.

38. The musical work of claim 37, wherein the providing includes instructing the random, virtual performers in how to meet a criteria desired for the select, virtual performance.

39. The musical work of claim 37, wherein the alignment component comprises a metronome track.

40. The musical work of claim 37, wherein the venue is provided by a network.

41. The musical work of claim 37, wherein the venue is coupled to a network.

42. The musical work of claim 37, wherein the venue is accessible by a handheld wireless device.

43. The musical work of claim 37, wherein the set of random performances comprises an individual performance, such that the select, virtual performer consists of a single performer.

44. The musical work of claim 37, wherein the set of random performances comprises a group performance, such that the select, virtual performer consists of a plurality of performers.
